(19) United States
(12) Patent Application Publication
(10) Pub. No.: US 2026/0079244 A1
(43) Pub. Date: Mar. 19, 2026

(54) INCREASING RANGE OF IMAGING SYSTEMS

(71) Applicant: SiLC Technologies, Inc., Monrovia, CA (US)

(72) Inventors: Nirmal Chindhu Warke, Saratoga, CA (US); Mehdi Asghari, La Canada Flintridge, CA (US); Prakash Koonath, La Crescenta, CA (US)

(21) Appl. No.: 18/886,983

(22) Filed: Sep. 16, 2024

(51) Int. Cl. G01S 7/4913; G01S 7/481; G01S 7/4912; G01S 7/4915; G01S 17/34; G01S 17/89

(52) U.S. Cl. CPC G01S 7/4913; G01S 7/4816; G01S 7/4817; G01S 7/4915; G01S 7/4918; G01S 17/34; G01S 17/89

(57) ABSTRACT

A LIDAR system has multiple comparative waveguides that are each configured to concurrently receive a different comparative signal. The comparative signals include light from a system return signal that has been reflected by an object outside of the LIDAR system. Each of the comparative signals includes light from the same system return signal. The LIDAR system is configured to generate data signals such that each of the data signals is generated from a different one of the comparative signals. The LIDAR system includes a switch configured to receive the data signals. The LIDAR system includes an analog-to-digital converter configured to receive the data signals from the switch.

### FIELD

The invention relates to optical devices. In particular, the invention relates to LIDAR systems.

### BACKGROUND

There is an increasing commercial demand for LIDAR systems that can be deployed in applications such as ADAS (Advanced Driver Assistance Systems) and AR (Augmented Reality). LIDAR (Light Detection and Ranging) systems typically output a system output signal that is reflected by an object located outside of the LIDAR system. At least a portion of the reflected light signal returns to the LIDAR system. The LIDAR system directs the received light signal to a light sensor that converts the light signal to an electrical signal. Electronics can use the light sensor output to quantify LIDAR data that indicates the radial velocity and/or distance between the object and the LIDAR system.

The LIDAR data results can become less reliable as the distance between the LIDAR system and the object increases due to the increased time delay for the reflected light to return to the LIDAR system. As a result, there is a need for LIDAR systems that can provide reliable LIDAR data results for objects at long distances from the LIDAR system.

### SUMMARY

A LIDAR system has multiple comparative waveguides that are each configured to concurrently receive a different comparative signal. The comparative signals include light from a system return signal that has been reflected by an object outside of the LIDAR system. Each of the comparative signals includes a different portion of the light from the same system return signal. The LIDAR system is configured to generate data signals such that each of the data signals is generated from a different one of the comparative signals. The LIDAR system includes a switch configured to receive the data signals. The LIDAR system includes an analog-to-digital converter configured to receive the data signals from the switch.

In some instances, the LIDAR system includes a switch controller configured to operate the switch so as to select which one of the data signals is received by the analog-to-digital converter. The switch controller can be configured to operate the switch such that the analog-to-digital converter receives different data signals in series.

In some instances, the LIDAR system is configured to transmit a system output signal that has a frequency versus time pattern with a chirp period during which a frequency of the system output signal is chirped at a substantially constant rate. The system return signal includes light from the system output signal. In some instances, the switch controller is configured to operate the switch such that the analog-to-digital converter receives multiple different data signals within a time period having a duration equal to a duration of the chirp period. The switch controller can be configured to operate the switch such that each of the data signals received by the ADC during the time period are generated from light that was included in the system output signal during the chirp period.

In some instances, the LIDAR system is configured such that when the object is positioned at less than a crossover distance from the LIDAR system a first one of the comparative waveguides receives the most powerful one of the comparative signals but when the object is positioned at greater than a crossover distance from the LIDAR system a second one of the comparative waveguides receives the most powerful of the comparative signals. The LIDAR system can be configured such that there is more than one crossover distance.

The LIDAR system can include a switch controller configured to operate the switch such that the data signal output from the switch changes at a time equal to (the start of the chirp period+the roundtrip time+/−20% of the roundtrip time) where the roundtrip time is the time for the system output signal to travel from the LIDAR system to the object and the system return signal to travel from the object to the LIDAR system when the object is positioned at the crossover distance from the LIDAR system.

### BRIEF DESCRIPTION OF THE FIGURES

FIG. 1 is a topview of a schematic of a LIDAR chip.

FIG. 2 is a topview of an example of a LIDAR adapter that is suitable for use with the LIDAR chip of FIG. 1.

FIG. 3 is a topview of an example of a LIDAR assembly that includes the LIDAR chip of FIG. 1 and the LIDAR adapter of FIG. 2 on a common support.

FIG. 4A is a topview of an example of a LIDAR system that includes the LIDAR assembly of FIG. 3 used in conjunction with system components.

FIG. 4B is a schematic of mirror suitable for use as a beam scanner in the LIDAR system of FIG. 4A.

FIG. 4C is a graph of optical loss versus distance for multiple different comparative waveguides.

FIG. 5A illustrates an example of a composite signal generator suitable for use with the LIDAR systems.

FIG. 5B provides a schematic of electronics that are suitable for use with composite signal generators constructed according to FIG. 5A.

FIG. 5C is a graph of frequency versus time for a system output signal with triangular frequency tuning.

FIG. 6 is a cross-section of portion of a LIDAR chip that includes a waveguide on a silicon-on-insulator platform.

FIG. 7 is a sideview of adjacent comparative waveguides taken at the facets of the comparative waveguides.

### DESCRIPTION

The LIDAR system is configured to output a system output signal having two or more different chirp periods repeated in cycles. An object outside of the LIDAR system can reflect the system output signal. At least a portion of the reflected light can return to the LIDAR system as a system return signal. The LIDAR system includes multiple comparative waveguides that can concurrently receive light from the system return signal such that the portion of the light from the system return signal that enters each of the comparative waveguides serves as a comparative signal guided by the comparative waveguide.

The LIDAR system is configured to generate data signals that are each an electrical signal generated from a different one of the comparative signals. The LIDAR system is configured such that the power of the data signal increases with increases in the power of the comparative signal from which the data signal was generated.

The LIDAR system includes a switch configured to receive the data signals. The LIDAR system also includes an analog-to-digital converter (ADC) configured to receive the data signals from the switch. The LIDAR system includes a switch controller configured to operate the switch so as to select which one of the data signals is received by the ADC. The LIDAR system can include a data processor that calculates LIDAR data from the output of the ADC. The LIDAR data can indicate the distance and/or radial velocity between the object and the LIDAR system.

The LIDAR system is constructed such that the comparative waveguide carrying the most powerful one of the comparative signals changes in response to changes in the distance between the object and the LIDAR system. For instance, the comparative waveguide carrying the most powerful one of the comparative signals can change as the object becomes further from the LIDAR system. As a result, the most powerful one of the data signals can change as the object becomes further from the LIDAR system.

The switch controller can operate the switch so the ADC receives the data signal generated from the most powerful one of the comparative signals when the object is at any distance from the LIDAR system within the operational range of the LIDAR system. The power of each of the data signals increases as the power of the comparative signal from which it was generated increases. Accordingly, the switch controller can operate the switch so the ADC receives the most powerful of the data signals when the object is at any distance from the LIDAR system within the operational range of the LIDAR system. Accordingly, the ADC can receive the most powerful of the data signals when the object is at the upper end of the LIDAR's systems operational range. As a result, the LIDAR data for the object is generated from the most powerful of the data signals when the object is at the upper end of the LIDAR's systems operational range. Generating the LIDAR data from the most powerful of the data signals when the object is at the upper end of the LIDAR's systems operational range increases the reliability of the LIDAR data for objects that are far from the LIDAR system.

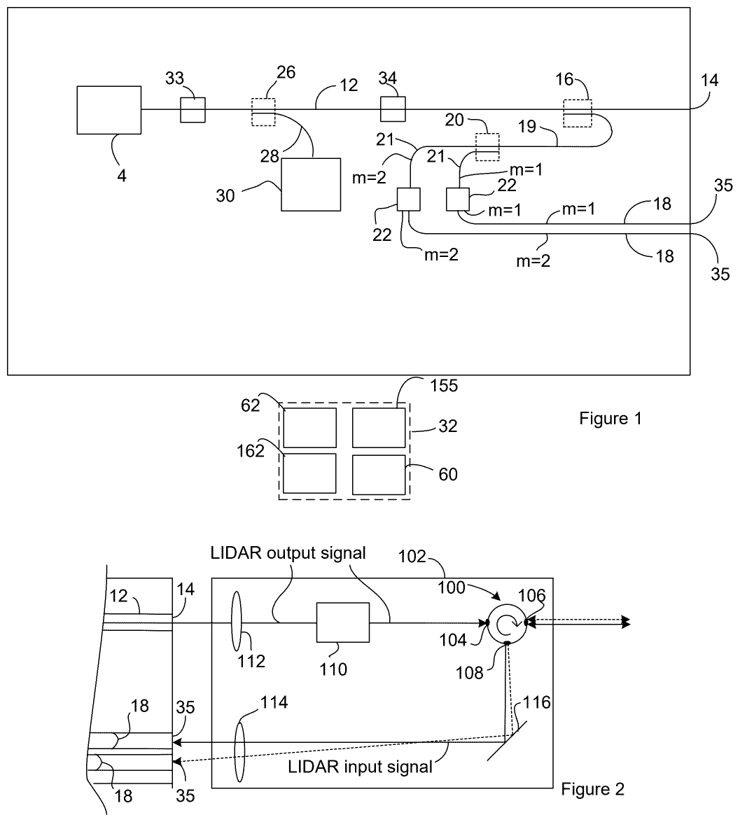

FIG. 1 is a topview of a schematic of a LIDAR chip. The LIDAR chip can be a semiconductor chip that includes a Photonic Integrated Circuit (PIC) and can be a Photonic Integrated Circuit chip. The LIDAR chip includes a light source 4 that outputs an outgoing LIDAR signal. A suitable light source 4 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

The LIDAR chip includes a utility waveguide 12 that receives an outgoing LIDAR signal from a light source 4. The utility waveguide 12 terminates at a facet 14 and carries the outgoing LIDAR signal to the facet 14. The facet 14 can be positioned such that the outgoing LIDAR signal traveling through the facet 14 exits the LIDAR chip and serves as a LIDAR output signal. For instance, the facet 14 can be positioned at an edge of the chip so the outgoing LIDAR signal traveling through the facet 14 exits the chip and serves as the LIDAR output signal.

The LIDAR system can be configured to output a system output signal that includes light from the LIDAR output signal. The system output signal travels away from the LIDAR system through free space. The LIDAR output signal may be reflected by one or more objects in the path of the system output signal. When the system output signal is reflected, at least a portion of the reflected light travels back toward the LIDAR chip as a system return signal. The LIDAR chip can receive a LIDAR input signal that includes light from the system return signal.

The LIDAR chip includes N comparative waveguides 18 that each terminates at a facet 35. N can be greater than or equal to 2. In FIG. 1, the LIDAR chip includes 2 comparative waveguides. Each of the N comparative waveguides 18 is associated with a channel index with an integer value from m=1 to m=N.

FIG. 1 illustrates the LIDAR input signal entering the LIDAR chip through the facet 35 of the comparative waveguide 18 labeled m=1. As will become evident below, the comparative waveguides 18 are arranged such that all or a portion of the comparative waveguides 18 can each receive a portion of a LIDAR input signal. The portion of the LIDAR input signal that enters each of the comparative waveguides 18 serves as a comparative signal carried by the comparative waveguide 18. Each of the comparative signals is associated with the channel index that is associated with the comparative waveguide 18 that carries the comparative signal.

Each of the comparative waveguides 18 carries the comparative signal to a composite signal generator 22 for further processing. Each of the composite signal generators 22 is associated with the channel index that is associated with the comparative signals received by the composite signal generators 22.

The LIDAR chip is configured to divide a portion of the outgoing LIDAR signal into multiple reference signals that are each received at a different one of the composite signal generators 22. For instance, the LIDAR chip illustrated in FIG. 1 includes a splitter 16 positioned along the utility waveguide 12. The splitter 16 receives the outgoing LIDAR signal and is configured to output a first portion of the outgoing LIDAR on a second portion of the utility waveguide 12. Accordingly, the first portion of the outgoing LIDAR can continue to serve as the outgoing LIDAR signal. The splitter 16 is also configured to output a second portion of the outgoing LIDAR signal on a preliminary reference waveguide 19 to serve as a preliminary reference signal. Suitable splitters 16 include, but are not limited to, directional couplers, optical couplers, y-junctions, tapered couplers, and Multi-Mode Interference (MMI) devices.

The LIDAR chip includes one or more reference splitters arranged so as to divide the preliminary reference signal into multiple different reference signals that are each associated with one of the channel indices. For instance, the LIDAR chip shown in FIG. 1 includes a reference splitter 20. The preliminary reference waveguide 19 carries the preliminary reference signal to the reference splitter 20. The reference splitter 20 divides the preliminary reference signal into multiple reference signals that are each associated with a different one of the channel indices. For instance, the reference splitter 20 outputs a first reference signal associated with the channel index m=1. The first reference signal is received on a reference waveguide 21 associated with the channel index m=1. The reference waveguide 21 associated with the channel index m=1 carries the first reference signal to the composite signal generator 22 associated with the same channel index. For instance, the reference waveguide 21 associated with the channel index m=1 carries the first reference signal to the composite signal generator 22 associated with the channel index m=1. The reference splitter 20 also outputs a second reference signal associated with the channel index m=2. The second reference signal is received on a reference waveguide 21 associated with the channel index m=2. The reference waveguide 21 associated with the channel index m=2 carries the second reference signal to the composite signal generator 22 associated with the same channel index. For instance, the reference waveguide 21 associated with the channel index m=2 carries the first reference signal to the composite signal generator 22 associated with the channel index m=2. Suitable reference splitters 20 include, but are not limited to, directional couplers, optical couplers, Y-junctions, tapered couplers, and Multi-Mode Interference (MMI) devices. When N is greater than 2, a single reference splitter 20 can be configured to divide the preliminary reference signal into the reference signals or multiple reference splitters 20 can be cascaded so as to divide the preliminary reference signal into the reference signals.

Each of the reference waveguides is associated with one of the channel indices. Each of the reference waveguides 21 carries the received reference signal to the composite signal generator 22 associated with the same channel index as the reference waveguide. Each of the reference signals is associated with the same channel index as the reference waveguide carrying the reference signal. As a result, each of the composite signal generators 22 receives a reference signal and a comparative signal associated with the same channel index. Accordingly, FIG. 1 illustrates the composite signal generator 22 associated with channel index m=2 receiving a reference signal from the reference waveguide labeled m=2 and a comparative signal from the comparative waveguide 18 labeled m=2. As will be described in more detail below, each of the composite signal generators 22 combines the received comparative signal with the reference signal to form a composite signal that carries LIDAR data for a sample region on the field of view. Accordingly, the composite signal can be processed so as to extract LIDAR data (radial velocity and/or distance between a LIDAR system and an object external to the LIDAR system) for the sample region.

The LIDAR chip can include a control branch suitable for use in generating a normalized beat frequency and/or controlling operation of the light source 4. The control branch includes a splitter 26 that moves a portion of the outgoing LIDAR signal from the utility waveguide 12 onto a control waveguide 28. The coupled portion of the outgoing LIDAR signal serves as a tapped signal. Although FIG. 1 illustrates a directional coupler operating as the splitter 26, other signal tapping components can be used as the splitter 26. Suitable splitters 26 include, but are not limited to, directional couplers, optical couplers, y-junctions, tapered couplers, and Multi-Mode Interference (MMI) devices.

The control waveguide 28 carries the control signal to a feedback system 30. The feedback system 30 can include one or more light sensors (not shown) that convert the control signals to electrical signals that are output from the feedback system 30. The electronics 32 can include a light source controller 62 configured to receive the electrical signals output from the feedback system 30. During operation, the light source controller 62 can adjust the frequency of the outgoing LIDAR signals in response to output from the electrical signals output from the feedback system 30. For instance, the light source controller 62 can adjust the frequency of the outgoing LIDAR signals so as to provide the outgoing LIDAR signals, and the resulting light signals, with the desired frequency versus time pattern. An example of a suitable construction and operation of feedback system 30 and light source controller 62 is provided in U.S. patent application Ser. No. 16/875,987, filed on 16 May 2020, entitled “Monitoring Signal Chirp in outbound LIDAR signals,” and incorporated herein in its entirety; and also in U.S. patent application Ser. No. 17/244,869, filed on 29 Apr. 2021, entitled “Reducing Size of LIDAR System Control Assemblies,”and incorporated herein in its entirety.

Although the light source 4 is shown as being positioned on the LIDAR chip, the light source 4 can be located off the LIDAR chip. For instance, the utility waveguide 12 can terminate at a second facet through which the outgoing LIDAR signal can enter the utility waveguide 12 from a light source 4 located off the LIDAR chip.

In some instances, a LIDAR chip constructed according to FIG. 1 is used in conjunction with a LIDAR adapter. In some instances, the LIDAR adapter can be physically optically positioned between the LIDAR chip and the one or more reflecting objects and/or the field of view in that an optical path that the first LIDAR input signal(s) and/or the LIDAR output signal travels from the LIDAR chip to the field of view passes through the LIDAR adapter.

Additionally, the LIDAR adapter can be configured to operate on the LIDAR input signal and the LIDAR output signal such that the LIDAR input signals and the LIDAR output signal travel on different optical pathways between the LIDAR adapter and the LIDAR chip but on the same optical pathway between the LIDAR adapter and a reflecting object in the field of view.

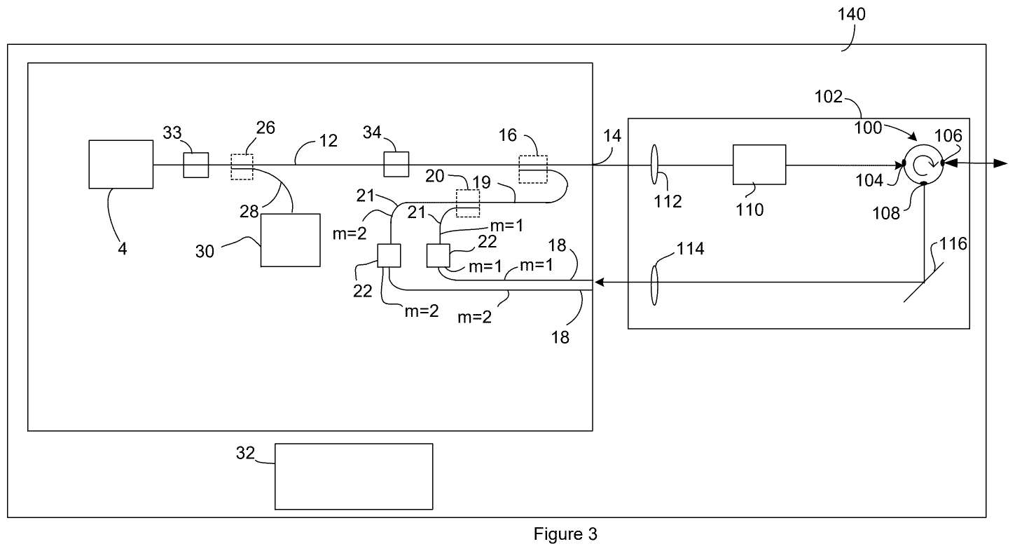

An example of a LIDAR adapter that is suitable for use with the LIDAR chip of FIG. 1 is illustrated in FIG. 2. The LIDAR adapter includes multiple components positioned on a base. For instance, the LIDAR adapter includes a circulator 100 positioned on a base 102. The illustrated optical circulator 100 includes three ports and is configured such that light entering one port exits from the next port. For instance, the illustrated optical circulator includes a first port 104, a second port 106, and a third port 108. The LIDAR output signal enters the first port 104 from the utility waveguide 12 of the LIDAR chip and exits from the second port 106.

The LIDAR output signal output from the LIDAR adapter includes, consists of, or consists essentially of light from the LIDAR output signal received from the LIDAR chip.

Accordingly, the LIDAR output signal output from the LIDAR adapter may be the same or substantially the same as the LIDAR output signal received from the LIDAR chip. However, there may be differences between the LIDAR output signal output from the LIDAR adapter and the LIDAR output signal received from the LIDAR chip. For instance, the LIDAR output signal can experience optical loss as it travels through the LIDAR adapter and/or the LIDAR adapter can optionally include an amplifier configured to amplify the LIDAR output signal as it travels through the LIDAR adapter.

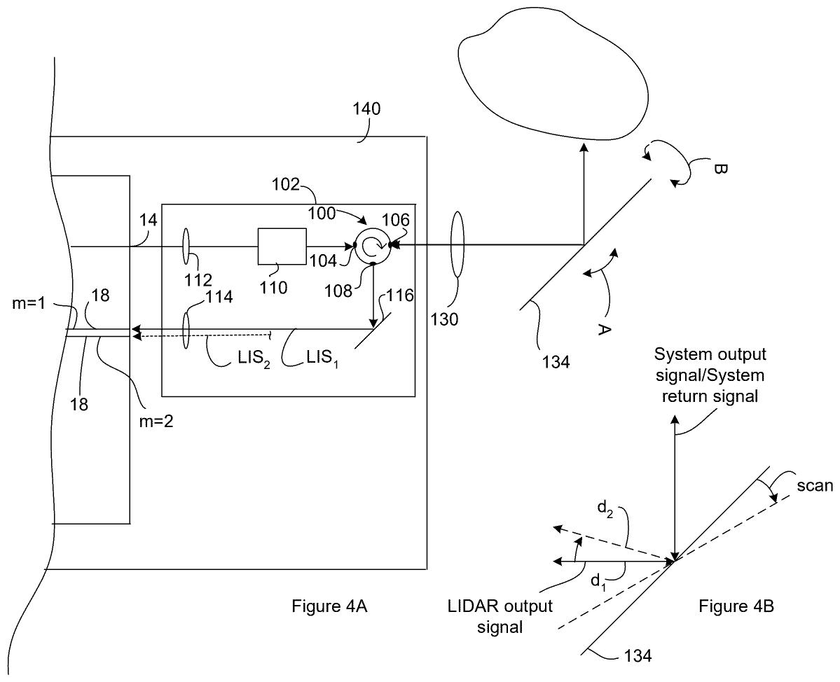

The system output signal transmitted by the LIDAR system can include light from the LIDAR output signal output from the LIDAR adapter. The system output signal travels away from the LIDAR system and can be reflected by one or more objects in the path of the system output signal. When the system output signal is reflected, at least a portion of the reflected light travels back toward the LIDAR chip as a system return signal. The LIDAR adapter can receive a LIDAR input signal that includes, consists of, or consists essentially of light from the system return signal. For instance, a LIDAR input signal that include light from the system return signal can enter the circulator 100 through the second port 106. FIG. 3 illustrates the LIDAR output signal being output from the LIDAR adapter along the same, or substantially the same, optical path as the LIDAR input signal received by the LIDAR adapter. However, the LIDAR output signal may be output from the LIDAR adapter along a different optical path from the LIDAR input signal received by the LIDAR adapter.

The LIDAR input signal exits the circulator 100 through the third port 108 and is directed to the comparative waveguide 18 on the LIDAR chip that is associated with channel index m=1. Accordingly, all or a portion of the system return signal can serve as the first comparative signal associated with channel index m=1. Accordingly, the LIDAR output signal and the LIDAR input signal travel between the LIDAR adapter and the LIDAR chip along different optical paths.

As is evident from FIG. 3, the LIDAR adapter can include optical components in addition to the circulator 100. For instance, the LIDAR adapter can include components for directing and controlling the optical path of the LIDAR output signal and the system return signal. As an example, the adapter of FIG. 3 includes an optional amplifier 110 positioned so as to receive and amplify the LIDAR output signal before the LIDAR output signal enters the circulator 100. The amplifier 110 can be operated by the electronics 32 allowing the electronics 32 to control the power of the LIDAR output signal and the resulting system output signal.

FIG. 3 also illustrates the LIDAR adapter including an optional first lens 112 and an optional second lens 114. The first lens 112 can be configured to couple the LIDAR output signal to a desired location. In some instances, the first lens 112 is configured to focus or collimate the LIDAR output signal at a desired location. In one example, the first lens 112 is configured to couple the LIDAR output signal on the first port 104 when the LIDAR adapter does not include an amplifier 110. As another example, when the LIDAR adapter includes an amplifier 110, the first lens 112 can be configured to couple the LIDAR output signal on the entry port to the amplifier 110. The second lens 114 can be configured to couple the LIDAR input signal at a desired location. In some instances, the second lens 114 is configured to focus or collimate the LIDAR output signal at a desired location. For instance, the second lens 114 can be configured to couple the LIDAR input signal on the facet 35 of the comparative waveguide 18.

The LIDAR adapter can also include one or more direction changing components such as mirrors. FIG. 3 illustrates the LIDAR adapter including a mirror as a direction-changing component 116 that redirects the LIDAR input signal from the circulator 100 to the comparative waveguide 18.

The LIDAR chips include one or more waveguides that constrains the optical path of one or more light signals. While the LIDAR adapter can include waveguides, the optical path that the system return signal and the LIDAR output signal travel between components on the LIDAR adapter and/or between the LIDAR chip and a component on the LIDAR adapter can be free space. For instance, when traveling between the different components on the LIDAR adapter and/or between a component on the LIDAR adapter and the LIDAR chip, the LIDAR input signal and/or the LIDAR output signal can travel through air, vacuum, the atmosphere in which the LIDAR chip, the LIDAR adapter, and/or the base 102 is positioned, or other medium. As a result, optical components such as lenses and direction changing components can be employed to control the characteristics of the optical path traveled by the LIDAR input signal and the LIDAR output signal on, to, and from the LIDAR adapter.

Suitable bases 102 for the LIDAR adapter include, but are not limited to, substrates, platforms, and plates. Suitable substrates include, but are not limited to, glass, silicon, and ceramics. The components can be discrete components that are attached to the substrate. Suitable techniques for attaching discrete components to the base 102 include, but are not limited to, epoxy, solder, and mechanical clamping. In one example, one or more of the components are integrated components and the remaining components are discrete components. In another example, the LIDAR adapter includes one or more integrated amplifiers, and the remaining components are discrete components.

When the LIDAR system includes a LIDAR chip and a LIDAR adapter, the LIDAR chip, electronics, and the LIDAR adapter can be positioned on a common mount. Suitable common mounts include, but are not limited to, glass plates, metal plates, silicon plates and ceramic plates. As an example, FIG. 3 is a topview of a LIDAR system that includes the LIDAR chip and electronics 32 of FIG. 1 and the LIDAR adapter of FIG. 2 on a common mount 128. Although the electronics 32 are illustrated as being located on the common support, all or a portion of the electronics can be located off the common support. When the light source 4 is located off the LIDAR chip, the light source can be located on the common mount 128 or off the common mount 128.

Although FIG. 3 illustrates the electronics 32 as located on the common mount 128, all or a portion of the electronics can be located off the common mount 128. When the light source 10 is located off the LIDAR chip, the light source can be located on the common mount 128 or off of the common mount 128. Suitable approaches for mounting the LIDAR chip, electronics, and/or the LIDAR adapter on the common mount 128 include, but are not limited to, epoxy, solder, and mechanical clamping. Suitable common mounts 128 include, but are not limited to, substrates such as glass plates, metal plates, silicon plates and ceramic plates.

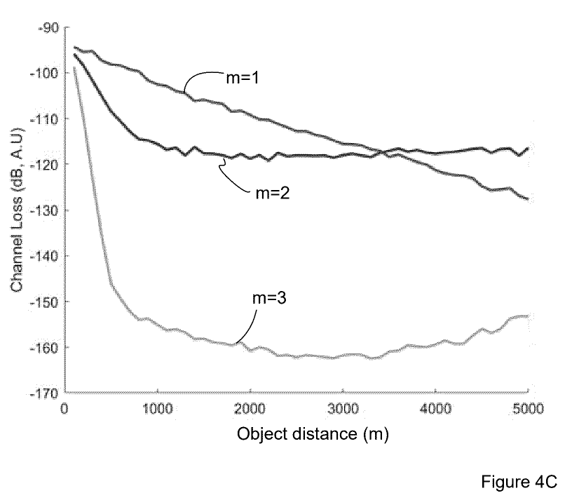

The LIDAR systems of FIG. 3 can include one or more system components that are at least partially located off the common mount 128. For instance, FIG. 4A illustrates a LIDAR system that includes system components in addition to the LIDAR assembly of FIG. 3. Examples of suitable system components include, but are not limited to, optical links, beam shapers, polarization state rotators, beam scanners, optical splitters, optical amplifiers, and optical attenuators. The LIDAR system of FIG. 4A includes one or more beam shapers 130 that receive the LIDAR output signal from the adapter and output a shaped signal. The one or more beam shapers 130 can be configured to provide the shaped LIDAR output signal with the desired shape. For instance, the one or more beam shapers 130 can be configured to output a LIDAR output signal shaped so as to be focused, diverging or collimated. In FIG. 4A, the one or more beam shapers 130 is a lens that is configured to output a collimated LIDAR output signal.

The LIDAR systems of FIG. 4A can optionally include one or more beam scanners 134 that receive the shaped LIDAR output signal from the one or more beam shapers 130. The portion of the LIDAR output signal that exits the LIDAR system serves as the system output signal. As a result, in the version of the LIDAR system illustrated in FIG. 4A, the portion of the LIDAR output signal output from the one or more beam scanners 134 serves as the system output signal. Suitable beam scanners include, but are not limited to, movable mirrors, MEMS mirrors, optical phased arrays (OPAs), optical gratings, actuated optical gratings and actuators that move the LIDAR chip, LIDAR adapter, and/or common mount 128.

When the system output signal is reflected by an object 136 located outside of the LIDAR system and the LIDAR, at least a portion of the reflected light returns to the LIDAR system as a system return signal. The portion of the system return signal that enters the LIDR system can serve as a LIDAR input signal. In the LIDAR system of FIG. 4A, the one or more beam scanners 134 receive light from the system return signal and output light from the system return signal that serves as the LIDAR input signal. The one or more beam shapers 130 receive the LIDAR input signal from the one or more beam scanners 134 and output a shaped system return signal that is received by the adapter.

The electronics 56 can include a steering controller 60 configured to operate the one or more beam scanners 134 so as to steer the system output signal to a series of different sample regions within the field of view of the LIDAR system. For instance, the steering controller 60 can move the one or more beam scanners 134 as illustrated by the arrow labeled A and/or the as illustrated by the arrow labeled B in FIG. 4A. Each of the sample regions can extend away from the LIDAR system to a maximum distance for which the LIDAR system is configured to provide reliable LIDAR data. The sample regions can be stitched together to define the field of view. For instance, the field of view of for the LIDAR system includes or consists of the space occupied by the combination of the sample regions. As a result, the sample regions can serve as three dimensional pixels that define the field of view for the LIDAR system.

In some instances, the one or more beam scanners 134 is a continuous scanner in that the direction of the system output signal continues to be scanned within a sample region as the system output signal illuminates the sample region. FIG. 4B illustrates a scanning mirror as an example of the one or more beam scanners 134. The solid line labeled “LIDAR output signal” represents the LIDAR output signal as it travels to the one or more beam scanners 134. The solid line labeled “system output signal” represents the system output signal as it travels away from the one or more beam scanners 134. The solid line labeled “system output signal” can also represent the system return signal as it travels from a reflecting object to the one or more beam scanners 134. The direction in which the one or more beam scanners 134 would direct a LIDAR input signal output from the one or more beam scanners 134 can be considered the scanner input direction. When a reflecting object is close to the LIDAR system, the solid line labeled “LIDAR output signal” can also approximate the LIDAR input signal output by the one or more beam scanners 134. Accordingly, the solid line labeled “LIDAR output signal” is also labeled “d₁” and can represent the scanner input direction for the LIDAR input signal when the object is close to the LIDAR system.

There is a time delay between the system output signal being transmitted by the LIDAR system and the system return signal being received by the LIDAR system. The amount of the time delay increases as a reflecting object becomes further from the LIDAR system. In FIG. 4B, the arc labeled “scan” represents movement of the one or more beam scanners 134 that occurs between the one or more beam scanners 134 transmitting the system output signal and the LIDAR system receiving the system return signal when the object is located far away from the LIDAR system. The re-location of the one or more beam scanners 134 during the delay of the system return signal changes the direction in which the one or more beam scanners 134 transmits the LIDAR input signal. For instance, the dashed line labeled d₂ can represent the scanner input direction that results from the re-location of the one or more beam scanners 134 during the delay of the system return signal.

The difference between the scanner input directions labeled “d₁” and “d₂” represents the change in the direction that the LIDAR input signal travels away from the one or more beam scanners 134 in response to movement of the object from close the LIDAR system to far from the LIDAR system. This change in direction causes the circulator 100 to receive the LIDAR input signal at a different location and/or at a different angle of incidence. The change to the location and/or angle of incidence at which the circulator 100 receives the LIDAR input signal causes the LIDAR input signal to travel a different optical path through the circulator. An example of a suitable circulator where a change to the location and/or angle of incidence at which the circulator 100 receives the LIDAR input signal causes the LIDAR input signal to travel a different optical path through the circulator can be found in U.S. patent application Ser. No. 17/221,770, filed on Apr. 2, 2021, entitled “Use of Circulator in LIDAR System,” and incorporated herein in its entirety.

The change in the optical paths that the LIDAR input signals travel through the circulator can change where the LIDAR input signal is incident on a LIDAR chip. As a result, the location where the LIDAR input signal is incident on a LIDAR chip can change in response to changes in the distance between the LIDAR system and the object. For instance, the change in the optical paths that the LIDAR input signals travel through the circulator can change where the LIDAR input signal is incident on the facet of a comparative waveguide. As a result, the location where the LIDAR input signal is incident on a facet of a comparative waveguide can change in response to changes in the distance between the LIDAR system and the object. The change in the optical paths that the LIDAR input signals travel through the circulator can be enough to reduce the power level of the LIDAR input signal to a level that is not sufficient for the generation reliable LIDAR data. As a result, the power level of the LIDAR input signal within a comparative waveguide can change in response to changes in the distance between the LIDAR system and the object.

The LIDAR chip includes multiple comparative waveguides that are each positioned to receive the LIDAR input signal. In some instances, the comparative waveguides concurrently receive different portions of the LIDAR input signal but the comparative waveguide that receives the most powerful portion of the LIDAR input signal changes in response to the distance of the object from the LIDAR system. As an example, the LIDAR input signal labeled LIS₁ in FIG. 4A can represent the comparative waveguide associated with channel index m=1 receiving the LIDAR input signal when the scanner input direction is “d₁”. Accordingly, the LIDAR input signal labeled LIS₁ in FIG. 4A can represent the comparative waveguide associated with channel index m=1 receiving the LIDAR input signal when the object is close to the LIDAR system. In contrast, the LIDAR input signal labeled LIS₂ in FIG. 4A can represent the comparative waveguide associated with channel index m=2 receiving the LIDAR input signal when the scanner input direction is “d₂”. Accordingly, the LIDAR input signal labeled LIS₂ in FIG. 4A can represent the comparative waveguide associated with channel index m=1 receiving the LIDAR input signal when the object is far from the LIDAR system.

FIG. 4C illustrates an example of the optical loss versus the object distance for comparative waveguides labeled m=1, m=2, and m=3. The channel indices are assigned so m=1 refers to the comparative waveguide that receives the highest power LIDAR input signals when the object is at the shortest distance from the LIDAR system for which the LIDAR system is configured to receive LIDAR data. Additionally, the channel indices are assigned so comparative waveguides that are further from the comparative waveguide associated with m=1 are assigned channel indices with higher values. As a result, the comparative waveguides labeled m=2 are physically located between the comparative waveguides 18 labeled m=1 and m=3.

As is evident from FIG. 4C, the comparative waveguides are configured to concurrently receive the LIDAR input signals and the resulting comparative signals. The relative power levels of the different comparative signals received by these comparative waveguides change in response to changes in the distance of the object from the LIDAR system. In FIG. 4C, the comparative signal associated with channel index m=1 experiences less loss than the comparative signal associated with channel index m=2 until the object exceeds a crossover distance of around 3500 m. After the object exceeds the crossover distance, the comparative signal associated with channel index m=2 experiences less loss than the comparative signal associated with channel index m=1. As a result, the power of the comparative signal carried by the comparative waveguide associated with channel index m=1 exceeds the power of the comparative carried by the comparative waveguide associated with channel index m=2 at object distances below about 3500 m from the LIDAR system. However, the power of the comparative signal carried by the comparative waveguide associated with channel index m=2 exceeds the power of the comparative signal carried by the comparative waveguide associated with channel index m=1 at object distances greater than about 3500 m from the LIDAR system. As a result, the LIDAR system is configured such that a first one of the comparative waveguides receives the most powerful one of the comparative signals but when the object is positioned at greater than a crossover distance from the LIDAR system a second one of the comparative waveguides receives the most powerful of the comparative signals. This switch in power levels at the crossover distance is a result of the LIDAR input signal shifting from comparative waveguide associated with channel index m=1 toward the comparative waveguide associated with channel index m=2 in response to an increasing distance of the object from the LIDAR system. For instance, the power switch can be a result of the LIDAR input signal moving from being incident on the facet of the comparative waveguide associated with channel index m=1 to the facet of the comparative waveguide associated with channel index m=2 in response to an increasing distance of the object from the LIDAR system. For the illustrated distances and LIDAR system construction, the power of the LIDAR input signal carried by the comparative waveguide associated with channel index m=3 does not exceed the power of the LIDAR input signals carried by the other comparative waveguides ay any of the illustrated distances. As a result, for the LIDAR system that provides the results of FIG. 4C, a third comparative waveguide may not be required. However, for other distances and/or LIDAR systems, more than two comparative waveguides may be desired. Although FIG. 4C illustrates a single crossover distance, a power loss versus distance graph can include more than one crossover distance.

Due the signal power relationships shown in the example of FIG. 4C, when an object is close, more reliable LIDAR data results can be calculated from the LIDAR input signal associated with channel index m=1, and the resulting comparative signal and the resulting composite signal than can be calculated from the LIDAR input signal associated with channel index m=2. However, when an object is further from the LIDAR system, more reliable LIDAR data results can be calculated from the LIDAR input signal associated with channel index m=2, and the resulting comparative signal and the resulting composite signal than can be calculated from the LIDAR input signal associated with channel index m=1.

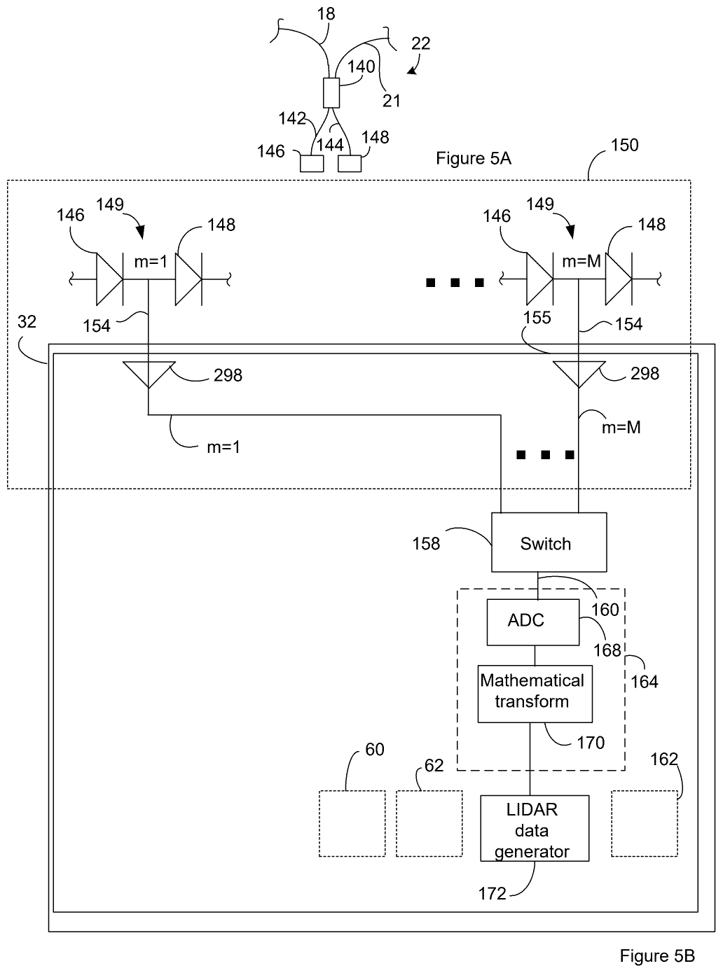

FIG. 5A illustrates an example of a composite signal generator 22 that is suitable for use as any, all, or each of the composite signal generators 22 in the LIDAR chip of FIG. 1. The illustrated composite signal generator 22 includes a light signal combiner 140 configured to receive light signals from one of the reference waveguides 21 and one of the comparative waveguides 18. When the reference waveguide 12 receives a reference signal, the reference waveguide 12 carries the reference signal to the light signal combiner 140. When a comparative waveguide 18 receives a comparative signal, the comparative waveguide 18 carries the comparative signal to the light signal combiner 140. When the light signal combiner 140 receives a comparative signal and a reference signal, the light signal combiner 140 combines the comparative signal and the reference signal into a composite signal. Due to a difference in frequencies between the comparative signal and the reference signal, the composite signal is beating at a beat frequency.

The light signal combiner 140 also splits the composite signal onto a first detector waveguide 142 and a second detector waveguide 144. The first detector waveguide 142 carries a first portion of the composite signal to a first light sensor 146 that converts the first portion of the composite signal to a first electrical signal. The second detector waveguide 144 carries a second portion of the composite signal to a second light sensor 148 that converts the second portion of the composite signal to a second electrical signal. Examples of suitable light sensors include germanium photodiodes (PDs), and avalanche photodiodes (APDs).

In some instances, the light signal combiner 140 splits the composite signal such that the portion of the comparative signal included in the first portion of the composite signal is phase shifted by 180° relative to the portion of the comparative signal in the second portion of the composite signal but the portion of the reference signal in the first portion of the composite signal is not phase shifted relative to the portion of the reference signal in the second portion of the composite signal. Alternately, the light signal combiner 140 splits the composite signal such that the portion of the reference signal in the first portion of the composite signal is phase shifted by 180° relative to the portion of the reference signal in the second portion of the composite signal but the portion of the comparative signal in the first portion of the composite signal is not phase shifted relative to the portion of the comparative signal in the second portion of the composite signal.

Suitable light signal combiners that can serve as the light signal combiner 140 include, but are not limited to, a Multi-Mode Interference (MMI) device such as a 2×2 MMI device. Other suitable light signal combiners include, but are not limited to, adiabatic splitters, and directional couplers. In some instances, the functions of the light signal combiner are performed by more than one optical component or a combination of optical components.

The LIDAR chip can include multiple composite signal generators 22 as shown in FIG. 1. FIG. 5B illustrates an example of a portion of the electronics configured to process the output from multiple different composite signal generators 22 that are each associated with a different one of the channel indices. The electronics 32 include a data signal generator 150 that includes the first light sensor 146 and the second light sensor 148 in each of the composite signal generators 22. The first light sensor 146 and the second light sensor 148 in each of the composite signal generators 22 can be connected as a balanced detector that serves as a light detector 149 that converts optical energy to electrical energy. As noted above, the different composite signal generators 22 are associated with different channel indices. Accordingly, the light detectors in different composite signal generator 22 are each associated with a different one of the channel indices.

The data signal generator 150 includes multiple detector output line 154. Each light detector is in electrical communication with a different one of the detector output lines 154 such that each of the detector output lines 154 carries the output signal of a different one of the light detectors as a data signal. For instance, the serial connection in the balanced detectors is in communication with one of the detector output lines 154. The electronics 32 include a data processor 155 configured to generate LIDAR data for the sample regions. Since the system output signals can be concurrently transmitted from the LIDAR system, there may be a data signal present on one or more of the detector output lines 154. As a result, there may be data signals associated with different channel indices concurrently present on different detector output lines 154.

The data processor 155 includes a switch 158 configured to receive each of the data signals from the light detectors 149. In particular, the switch 158 can be configured to receive the data signals from the from the detector output lines 154. As a result, each of the detector output lines 154 can serve as a switch input line. As is evident from FIG. 4C, there may be data signals concurrently present on one or more of the detector output lines 154. As a result, there may be data signals associated with different channel indices concurrently present on different detector output lines 154.

The switch 158 is operable so as to output a selection of the data signals on an analog signal line 160. Accordingly, the switch 158 can be operated so as to select which of the data signals are output on the analog signal line. In some instances, the selection of the data signals output on an analog signal line 160 is a single one of the data signals. For instance, the switch 158 can be operated such that the data signal associated with channel index m=1 is output on the analog signal line and the other data signals are not output on the analog signal line, or are not substantially output on the analog signal line. The switch can subsequently be operated such that a different selection of the data signals is output on the analog signal line. As a result, the switch 158 can be operated such that data signals associated with different channel indices are serially output on the analog signal line. Accordingly, the analog-to-digital converter can receive data signals associated with different channel indices in series. The electronics can include a switch controller 162 configured to operate the switch 158 so as to select the selection of the data signals that are output from the switch 158. The switch 158 can include more than one switch. For instance, the switch 158 can include cascaded 1×2 switches. Suitable switches include, but are not limited to, an N×1 switch, an N to 1 switch, a data selector, and an electrical multiplexer.

The data processor 155 includes a beat frequency identifier 164 that receives the data signals from the switch 158. In particular, the beat frequency identifier 164 can be configured to serially receive from the analog signal line 160 data signals associated with different channel indices. The beat frequency identifier 164 is configured to identify the beat frequency of the data signal. The beat frequency identifier 164 includes an Analog-to-Digital Converter (ADC) 168 that receives the data signals from the analog signal line 160. The Analog-to-Digital Converter (ADC) 168 converts the data signal from an analog form to a digital form and outputs a digital data signal. The digital data signal is a digital representation of the data signal. Accordingly, the digital data signals are each associated with one of the channel indices. Since the switch controller 162 can operate the switch 158 such that data signals associated with different channel indices are serially output on the analog signal line, the Analog-to-Digital Converter (ADC) 168 serially receives data signals that are associated with different channel indices and outputs digital data signals that are associated with different channel indices.

The beat frequency identifier 166 includes a mathematical transformer 170 configured to receive the digital data signals. The mathematical transformer 170 is configured to perform the mathematical operation on the received digital data signal. Examples of suitable mathematical operations include, but are not limited to, mathematical transforms such as Fourier transforms. In one example, the mathematical transformer 170 performs a Fourier transform on the digital signal so as to convert from the time domain to the frequency domain. The mathematical transform can be a real transform such as a real Fast Fourier Transform (FFT). A real Fast Fourier Transform (FFT) can provide an output that indicates magnitude as a function of frequency.

The mathematical transformer 170 can include a peak finder (not shown) configured to identify peaks in the output of the mathematical transformer 170. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal.

The electronics include a LIDAR data generator 172 that receives the output from the mathematical transformer 170. For instance, the LIDAR data generator 172 can receive beat frequency from the LIDAR data generator 172. The LIDAR data generator 172 treats the frequency at the identified peak as the beat frequency of the comparative signal beating against all or a portion of a reference signal. The LIDAR data generator 172 can use the received beat frequencies in combination with the frequency pattern of the LIDAR output signals and/or the system output signals to generate LIDAR data results.

FIG. 5C illustrates an example of suitable frequency patterns for the outgoing LIDAR signal, and the resulting system output signals and LIDAR output signals. The light source controller 62 can operate the light source 10 such that the outgoing LIDAR signals output from the light source 10 have a frequency versus time pattern according to FIG. 5C. The frequency versus time patterns can be periodic. The outgoing LIDAR signal has a frequency versus time pattern that periodically repeats in cycles. The different cycles are labeled Cₖ where k is a cycle index. As a result, C₁₀ can represent the tenth cycle of the system output signal.

Each cycle includes multiple chirp periods labeled CPⱼ where j is a chirp period index with a value from 1 to J. Accordingly, CP₂ represents the second chirp period in each of the cycles. Each of the cycles shown in FIG. 5C includes two chirp periods (J=2). The duration of different chirp periods in the same cycle can optionally be the same or can be different. In FIG. 5C, the chirp periods have the same duration. The chip rate can be constant, or substantially constant during each of the chirp periods in a cycle. As a result, the chirp can be a linear chirp. The chirp rates for the chirp periods in the same cycle can be the same or different and can be in the same or different directions. For instance, the chirp rates in each chirp period of FIG. 5C are the same but the chirp direction in different chirp periods within the same cycle are in opposite directions. The start time of each cycle coincides with the start of one of the chirp periods in the cycle.

The chirp period indices can be assigned such that corresponding chirp periods in different cycles are assigned the same chirp period index. For instance, FIG. 5C shows each of the chirp periods with an increasing frequency are assigned a chirp period index with a value of 1 while each of the chirp periods with a decreasing frequency are assigned a chirp period index with a value of 2.

The total change in the frequency that occurs during a chirp period can be considered a magnitude of the frequency change during the chirp period (chirp bandwidth). The chirp bandwidth during the chirp periods in the same cycle can be the same or different. In FIG. 5C, the chirp bandwidth during each of the chirp periods is constant or substantially constant; however, a portion of the chirp periods have different directions for the total change in the frequency that occurs during a chirp period.

As noted above, the switch controller 162 can operate the switch 158 so as to control which one of the data signals is received at the Analog-to-Digital Converter (ADC) 168. FIG. 5C illustrates the relationship between the frequency versus time patterns and the receipt of different data signals at the Analog-to-Digital Converter (ADC) 168. For instance, FIG. 5C includes multiple different switch windows labeled W_{m,j} where m represents the channel index and j represents the chirp period index. A switch window represents the time period during which the switch controller 162 directs the data signal associated with a particular one of the channel indices to the Analog-to-Digital Converter (ADC) 168. For instance, the switch windows labeled W_{2,2} represents a time period where the switch controller 162 directs the data signal associated with channel index m=2 to the Analog-to-Digital Converter (ADC) 168 during a second chirp period (j=2). FIG. 5C illustrates the switch controller operating the switch such that the analog-to-digital converter receives multiple different data signals within a time period having a duration equal to the duration of the chirp periods. Additionally, FIG. 5C illustrates the switch controller operating the switch such that each of the data signals received by the ADC during the duration of each chirp period are generated from light that was included in the system output signal during the chirp period.

The switch windows are each associated with the cycle that includes the switch window. For instance, in FIG. 5C, each of the cycles is associated with four different switch windows. As an example, each of the cycles in FIG. 5C is associated with four switch windows labeled W_{1,1}, W_{1,2}, W_{2,1}, W_{2,2}.

Each of the switch windows is associated with the chirp period that includes the switch window. As a result, each of the switch windows in the same cycle is associated with the chirp period having the same chirp period index. For instance, the switch windows W_{m,j} is associated with the chirp period CPⱼ from the same cycle. As an example, in FIG. 5C, the switch windows labeled W_{1,2} and W_{2,2} and associated with the same cycle are each associated with the chirp period CP₂.

The beat frequency identifier 164 can identify the beat frequency of the data signal received by the Analog-to-Digital Converter (ADC) 168 during a switch window (W_{m,j} ). For instance, the mathematical transform 170 can sample the digital data signals during a sample window labeled t_{bf} in FIG. 5C. For instance, when the mathematical transform 170 performs a Fourier transform, the sample window can represent the time during which the mathematical transform 170 integrates the digital data signals as to perform the integration functionality of the Fourier transform. The sample windows are at the end of each switch window to increase the time that is available for the system return signal to return to the LIDAR system before the integration of the digital data signals.

The beat frequencies are each associated with the cycle that is associated with the switch window from which the beat frequency was generated. The switch windows are arranged such that during each chirp period, the switch window associated with channel index m=1 occurs before the switch window associated with channel index m=2. As is evident from the above discussion of FIG. 4A, when a reflecting object is close to the LIDAR system, the LIDAR input signal and the resulting comparative signal received on the comparative waveguide associated with channel index m=1 have more power than the LIDAR input signal and the resulting comparative signal received on the comparative waveguide associated with channel index m=2 but when the reflecting object moves further from the LIDAR system, the channel index of the comparative waveguide that receives the LIDAR input signal and/or the channel index associated with the comparative signal with the most power can increase. The comparative signals are each used in generating data signals as described above. When the switch window has m=1, the data signal associated with channel index m=1 is received by the ADC. However, when the switch window has m=2, the data signal associated with channel index m=2 is received by the ADC. As a result, LIDAR data generated from switch windows with m=1 provides more reliable LIDAR data for close objects while LIDAR data generated from switch windows with m=2 provide more reliable data for more distant objects. Since each chirp period has the switch window associated with channel index m=1 occurring before the switch window associated with channel index m=2, the chirp periods have the ADC receiving the data signals that provide more reliable LIDAR data for close object before receiving the data signal that provide more reliable LIDAR data for further objects. Since the LIDAR system receives system return signals from a closer object before receiving system return signals from a further object, the time after the start of a chirp period for the LIDAR system to begin generating data signals increases as the object is further from the LIDAR system. Configuring the switch windows so the time delay for the ADC to receive the data signals after the start of each chirp period increases as the distance of the object from the LIDAR system increases and provides additional roundtrip time for the system output signal to travel from the LIDAR system to an object and the resulting system return signal to return to the LIDAR system for objects that are further from the LIDAR system.

In some instances, each chirp period includes one or more switch windows that close at a time period equal to (the start of the chirp period plus at the roundtrip time for an object positioned at one of the crossover distances). When the LIDAR system is constructed such that there is only one crossover distance in the loss versus distance graph for the LIDAR system (FIG. 4C), each chirp period can include one switch window that close at a time period equal to (the start of the chirp period plus the roundtrip time for an object positioned at the crossover distances). When the LIDAR system is constructed such that there more than one crossover distance in the loss versus distance graph for the LIDAR system (FIG. 4C), each chirp period can include one multiple switch windows that each close at a time period equal to (the start of the chirp period plus the roundtrip time for an object positioned at one of the crossover distances). As an example, FIG. 5C illustrates the switch windows associated with channel index m=1 opening at the start of a chirp period and the duration of each switch window associated with channel index m=1 is the roundtrip time for an object that is the crossover distance from the LIDAR system. In the example of FIG. 4C, the crossover distance is about 3500 m. When the switch windows associated with channel index m=1 opens at the start of a chirp period and the duration of the switch window associated with channel index m=1 is the roundtrip time for an object that is at the crossover distance from the LIDAR system; the ADC receives data signals that result from an object being located at less than the crossover distance during the switch window associated with channel index m=1, but when an object is positioned further than the crossover distance the ADC receives data signals during the switch window associated with channel index m=2. In the example of FIG. 4C, when the object is located at less than the crossover distance the most powerful LIDAR input signals are received by the comparative waveguide associated with channel index m=1 but when the object is located further than the crossover distance the most powerful LIDAR input signals are received by the comparative waveguide associated with channel index m=2. Accordingly, the ADC continues receive the data signals generated from the most powerful comparative signals regardless of where the object is positioned within the operational range of the LIDAR system. The operational range of the LIDAR system is the range of the LIDAR system for which the LIDAR system is configured to provide reliable LIDAR data. The power of each data signal increases as the power of the comparative signal from which it was generated increases. As a result, the ADC receiving the data signals generated from the most powerful comparative signals when the object is positioned at any location within the operational range of the LIDAR system results in the ADC receiving the most powerful data signal when the object is positioned at any location within the operational range of the LIDAR system.

A loss versus distance diagram such as FIG. 4C can include more than one crossover distance. Additionally, the LIDAR chip can include more than two comparative waveguides. As a result, the switch windows can be configured such that one or more of the switch windows within each, or a portion, of the chirp periods closes at a time equal to the start of the chirp period plus the roundtrip time for an object that is at one of crossover distances from the LIDAR system +/−20%, +/−5%, or +/−1 % of that roundtrip time. As an example, the switch windows in FIG. 5C can be configured such as the duration of each switch window labeled w_{1,1} and each switch window labeled w_{1,2} is equal to the roundtrip time for an object that is at the crossover distance shown in FIG. 4C (about 23 μs). As a result, the switch windows in FIG. 5C can be configured such that the switch windows within each of the chirp periods closes at a time equal to the start of the chirp period plus the roundtrip time for an object that is at the crossover distance shown in FIG. 4C +/−0% of that roundtrip time. Accordingly, the chirp periods need not include a switch window that closes at precisely the start of the chirp period plus the roundtrip time for an object at a crossover distance but can include one or more switch windows that close at a time that is substantially or approximately the start of the chirp period plus the roundtrip time for an object at a crossover distance.

FIG. 5C also illustrates multiple sample regions. The sample regions can be represented by SRₖ where k represents the cycle index. As a result, the cycle index can also be considered a sample region index. The sample region SRₖ represents the portion of the LIDAR system's field of view that is illuminated by the system output signal during the chirp periods that are used to generate LDAR data for that sample region. More particularly, the sample region SRₖ represents the portion of the LIDAR system's field of view that is illuminated by the system output signals during the chirp periods that include switch windows that are the source of the beat frequencies that are used to calculate the LDAR data for the sample region SRₖ. In FIG. 5C, the chirp periods and switch windows that are used to generate LDAR data for each sample region are from the same cycle. As a result, each sample region is associated with a cycle.

As noted above, the sample regions can serve as three-dimensional pixels that can be stitched together to define the field of view for the LIDAR system. Each of the LIDAR data results generated by the LIDAR data generator 172 represents the LIDAR data for a sample region. The LIDAR data for a sample region can indicate the radial velocity and/or distance between the LIDAR system and an object in the sample region.

Since the reference signals, LIDAR output signals, LIDAR input signals, comparative signals, and the system output signals include or consist of light from the outgoing LIDAR signals, these signals exhibit the characteristics attributed to the outgoing LIDAR signal in the context of FIG. 5C.

The LIDAR data generator 172 can combine the beat frequencies from multiple different composite signal generators 22 to generate a LIDAR data result for each of the sample regions. For instance, the LIDAR data generator 172 can combine the beat frequencies calculated from multiple different switch windows that are each associated with the same cycle, with the same channel index, and different chirp periods to calculate LIDAR data result for each of the sample regions. As an example using FIG. 5C, a LIDAR data generator 172 can calculate the LIDAR data results for sample region SRₖ₊₁ from the beat frequencies identified from the switch windows that are labeled w_{1,1} and w_{1,2} and that are associated with cycle Cₖ₊₁ or the LIDAR data generator 172 can calculate the LIDAR data results for same sample region (SRₖ₊₁) from the beat frequencies identified from the switch windows that are labeled w_{2,1} and w_{2,2} and that are associated with cycle Cₖ₊₁.

The following equation applies to beat frequencies generated from switch windows where the frequency of the system output signal increases during the switch window such as occurs during the switch window W_{1,1} of the cycle labeled Cₖ₊₁ in FIG. 5C: f_{ub}=−f_{d}+α_{uτ0} where f_{ub} is a beat frequency identified by the beat frequency identifier 164 and is associated with the switch window, ƒ_{d} represents the Doppler shift (f_{d}=2νfₒ/c) where f₀ is the frequency of the system output signal at the start of the data period that includes the switch window, ν is the radial velocity between the reflecting object and the LIDAR chip where the direction from the reflecting object toward the chip is assumed to be the positive direction, and c is the speed of light, αᵤ represents the chirp rate during the sample period, and τ₀ is the roundtrip time (time between the system output signal exiting from the LIDAR system and the system return signal returning to the LIDAR system) for a stationary reflecting object. The following equation applies to beat frequencies generated from switch windows where the frequency of the system output signal increases during the switch window such as occurs during the switch window W_{1,2} of the cycle labeled Cₖ₊₁ in FIG. 5C: −f_{d}−α_{dτ0} where f_{db} is a beat frequency identified by the beat frequency identifier 164 and is associated with the switch window and α_{d} represents the chirp rate during the sample period. In these two equations, f_{d} and τ₀ are unknowns. These two equations are solved for the two unknowns f_{d} and τ₀. The LIDAR DATA generator can substitute the beat frequencies associated with the same cycle into the solution to generate the LIDAR data for the sample region associated with the cycle. For instance, the LIDAR DATA generator can calculate the radial velocity for an object in a sample region from the Doppler shift (ν=c*f_{d}/(2f_{c})) and/or the separation distance for the object in the sample region from c*τ₀/2. As an example, to generate a first LIDAR data result for the sample region labeled SRₖ₊₁ in FIG. 5C, the LIDAR DATA generator can substitute the beat frequency identified from the data signal received by the ADC during switch window W_{1,1} of the cycle labeled Cₖ₊₁ and the beat frequency identified from the data signal received by the ADC during switch window W_{1,2} of the cycle labeled Cₖ₊₁ into the solution to calculate the radial velocity for an object in the sample region labeled SRₖ₊₁ in FIG. 5C from the Doppler shift (ν=c*f_{d}/(2f_{c})) and/or the separation distance for the object in the sample region from c*τ₀/2. The LIDAR data can calculate a second LIDAR data result for the sample region labeled SRₖ₊₁ by substituting the beat frequency identified from the data signal received by the ADC during switch window W_{2,1} of the cycle labeled Cₖ₊₁ and the beat frequency identified from the data signal received by the ADC during switch window W_{2,2} of the cycle labeled Cₖ₊₁ into the solution. Since the first LIDAR data result is generated from switch windows associated with the channel index m=1, the first LIDAR data result is associated with the channel index m=1. Since the second LIDAR data result is generated from switch windows associated with the channel index m=2, the first LIDAR data result is associated with the channel index m=2. Accordingly, in some instances, the LIDAR data generator can calculate one or more LIDAR data solutions for all or a portion of the sample regions.

When an object is far from the LIDAR system, the data signals may not have a beat frequency during one or more switch windows that occur early in a chirp period. When the last switch window during a chirp period is the only one that provides data signals with a beat frequency, the LIDAR data generator can treat that beat frequency as the beat frequency that accurately represents the beat frequency for the chirp period (the representative beat frequency). The LIDAR data generator can use the representative beat frequency to calculate the representative LIDAR data result for a sample region associated with the chirp period. In contrast, when an object is close to the LIDAR system, the data signals may have a beat frequency during multiple different switch windows associated with the same chirp period. As a result, in some circumstances, it may be possible for the LIDAR data generator to generate multiple different LIDAR data results for a sample region. For instance, the LIDAR data generator may be able to generate the first LIDAR data result and the second LIDAR data result for the same sample region as described above.

Since the beat frequency identifier can identify multiple different beat frequencies for the same chirp period, the LIDAR data generator can screen the beat frequencies identified for the same chirp period so as to identify the beat frequency that accurately, or most accurately, represents the beat frequency for the chirp period (the representative beat frequency for the chirp period). The screening of the beat frequencies can serve as screening of LIDAR data results so as to identify the LIDAR data result that are most likely to accurately represent the LIDAR data for the sample region (the representative LIDAR data). For instance, the multiple different beat frequencies for the same chirp period can each serve as a candidate beat frequency for the chirp period. The LIDAR data generator can select from among the candidate beat frequencies for a chirp period the candidate beat frequency generated from the most powerful comparative signal and/or the most powerful composite signal to serve as the representative beat frequency for the chirp period. When a Fourier transform, such as a real or complex FFT, is used to identify the beat frequency, the most powerful comparative signal and/or the most powerful composite signal can be identified as the source of highest peak, or most intense peak, in the output of the Fourier transform. As a result, when a Fourier transform is used to identify the beat frequency, the peak finder can identify the beat frequency that has the highest peak in the output of a Fourier transform as the representative beat frequency for the chirp period. The LIDAR data generator can combine the representative beat frequency for the chirp period with one or more representative beat frequencies from other chirp periods as described above to calculate a LIDAR data result for the sample region associated with the combined beat frequencies and the result can serve as the representative LIDAR data.

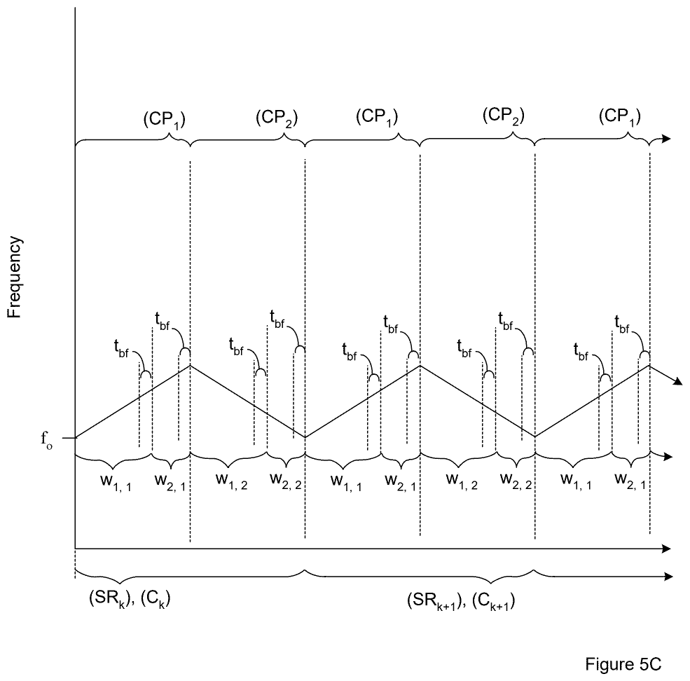

Suitable platforms for construction for a LIDAR chip include, but are not limited to, silicon-on-insulator wafers, silica wafers, and silicon nitride on silicon wafers. FIG. 6 illustrates a portion of a LIDAR chip that includes a waveguide with a construction that is suitable for use with chips constructed from silicon-on-insulator wafers. A ridge 306 of the light-transmitting medium 304 extends away from slab regions 308 of the light-transmitting medium 304. The light signals are constrained between the top of the ridge and the buried layer 300. As a result, the ridge 306 at least partially defines the waveguide.

The dimensions of the ridge waveguide are labeled in FIG. 6. For instance, the ridge has a width labeled w and a height labeled h. The thickness of the slab regions is labeled t. For LIDAR applications, these dimensions can be more important than other applications because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 6 is suitable for all or a portion of the waveguides on the LIDAR chip.

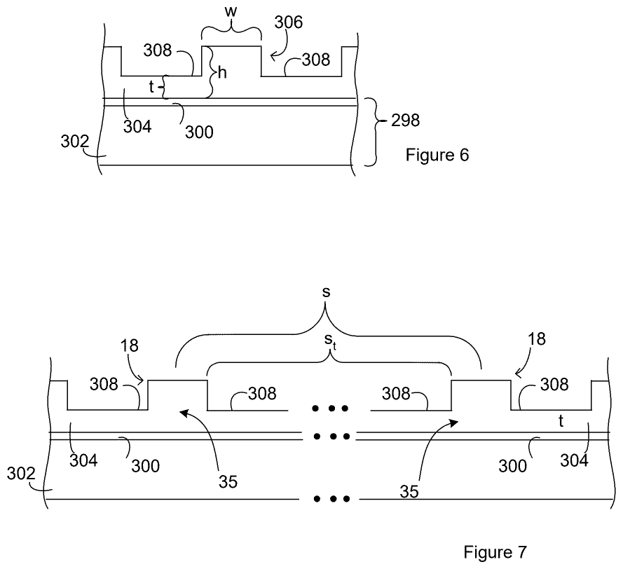

FIG. 7 is a sideview of adjacent comparative waveguides 18 at the facets 35 of the comparative waveguides 18. When the facets 35 of the comparative waveguides 18 have one or more layers such as an anti-reflective coating, the one or more layers are treated as transparent in FIG. 7. The distance between the centers of adjacent comparative waveguides at the facets 35 is labeled s in FIG. 7. Suitable distances between the centers of adjacent comparative waveguides at the facets 35 (s) include, but are not limited to, distances greater than or equal to 0.5 μm, 1 μm, and 3 μm and less than or equal to 4 μm, 6 μm, and 10 μm. The distance between the closest lateral sides of adjacent comparative waveguides at the facets 35 is labeled sₜ in FIG. 7. Suitable distances between the closest lateral sides of adjacent comparative waveguides at the facets 35 (sₜ) include, but are not limited to, distances greater than or equal to 0.5, 1, and 2 μm and less than or equal to 3, 4, and 8 μm.

Light sensors that are interfaced with waveguides on a LIDAR chip can be a component that is separate from the chip and then attached to the chip. For instance, the light sensor can be a photodiode, or an avalanche photodiode. Examples of suitable light sensors include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first light sensor and the second light sensor.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10, 2012; U.S. Pat. No. 8,242,432, issued Aug. 14, 2012; and U.S. Pat. No. 6,108,472, issued on Aug. 22, 2000 each of which is incorporated herein in its entirety. The use of light sensors that are integrated with the chip are suitable for all or a portion of the light sensors selected from the group consisting of the first light sensor and the second light sensor.

Suitable electronics 32 can include, but are not limited to, a controller that includes or consists of analog electrical circuits, digital electrical circuits, processors, microprocessors, digital signal processors (DSPs), Field Programmable Gate Arrays (FPGAs), computers, microcomputers, or combinations suitable for performing the operation, monitoring and control functions described above. In some instances, the controller has access to a memory that includes instructions to be executed by the controller during performance of the operation, control and monitoring functions. In some instances, the functions of a LIDAR data generator and the peak finder can be executed by Field Programmable Gate Arrays (FPGAs), digital signal processors (DSPs), Application Specific Integrated Circuits, firmware, software, hardware, and combinations thereof. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

An example of a suitable light source controller 62 executes the attributed functions using firmware, hardware, or software or a combination thereof. An example of a suitable data processor 155 executes the attributed functions using firmware, hardware, or software or a combination thereof. An example of a suitable steering controller 60 executes the attributed functions using firmware, hardware, or software or a combination thereof.

Components on the LIDAR chip can be fully or partially integrated with the LIDAR chip. For instance, the integrated optical components can include or consist of a portion of the wafer from which the LIDAR chip is fabricated. A wafer that can serve as a platform for a LIDAR chip can include multiple layers of material. At least a portion of the different layers can be different materials. As an example, in a silicon-on-insulator wafer that includes the buried layer 300 between the substrate 302 and the light-transmitting medium 304 as shown in FIG. 6, the integrated on-chip components can be formed by using etching and masking techniques to define the features of the component in the light-transmitting medium 304. For instance, the slab regions 308 that define the waveguides and the stop recess can be formed in the desired regions of the wafer using different etches of the wafer. As a result, the LIDAR chip includes a portion of the wafer and the integrated on-chip components can each include or consist of a portion of the wafer. Further, the integrated on-chip components can be configured such that light signals traveling through the component travel through one or more of the layers that were originally included in the wafer. For instance, the waveguide of FIG. 7 guides light signal through the light-transmitting medium 304 from the wafer. The integrated components can optionally include materials in addition to the materials that were present on the wafer. For instance, the integrated components can include reflective materials and/or a cladding.

Numeric labels such as first, second, third, etc. are used to distinguish different features and components and do not indicate sequence or existence of lower numbered features. For instance, a second component can exist without the presence of a first component and/or a third step can be performed before a first step. The light signals disclosed above each include, consist of, or consist essentially of light from the prior light signal(s) from which the light signal is derived. For instance, an incoming LIDAR signal includes, consists of, or consists essentially of light from the LIDAR input signal.

Although the LIDAR system is disclosed as real signals such as the data signal, the LIDAR system can also use complex signals. As a result, the mathematical transform can be a complex transform and the component associated with the generation and use of a complex data signal having an in-phase component and a quadrature component can be added to the LIDAR system. As a result, the LIDAR system can use a multiple signal combiners and multiple ADCs. Additionally, or alternately, a single light sensor can replace each of the balanced detectors.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
having multiple comparative waveguides that are each configured to concurrently receive a different comparative signal,
the comparative signals including light from a system return signal that has been reflected by an object outside of the LIDAR system and each of the comparative signals including light from the same system return signal;
the LIDAR system configured to generate data signals such that each of the data signals is generated from a different one of the comparative signals;
the LIDAR system including a switch configured to receive the data signals;
the LIDAR system including an analog-to-digital converter configured to receive the data signals from the switch.

2. The system of claim 1, wherein the LIDAR system includes a switch controller configured to operate the switch so as to select which one of the data signals is received by the analog-to-digital converter.

3. The system of claim 2, wherein the switch controller is configured to operate the switch such that the analog-to-digital converter receives different data signals in series.

4. The system of claim 3, wherein the LIDAR system is configured to transmit a system output signal and the system return signal includes light from the system output signal,
the system output signal having a frequency versus time pattern that includes a chirp period during which a frequency of the system output signal is chirped at a substantially constant rate.

5. The system of claim 4, wherein the LIDAR system includes a switch controller configured to operate the switch such that the analog-to-digital converter receives multiple different data signals within a time period having a duration equal to a duration of the chirp period.

6. The system of claim 5, wherein the switch controller is configured to operate the switch such that each of the data signals received by the ADC during the time period are generated from light that was included in the system output signal during the chirp period.

7. The system of claim 6, wherein the LIDAR system is configured such that when the object is positioned at less than a crossover distance from the LIDAR system a first one of the comparative waveguides receives the most powerful one of the comparative signals but when the object is positioned at greater than a crossover distance from the LIDAR system a second one of the comparative waveguides receives the most powerful of the comparative signals; and
the switch controller is configured to operate the switch such that the data signal output from the switch changes at a time equal to the start of the chirp period plus a roundtrip time +/−20% of the roundtrip time,
the roundtrip time being a time for the system output signal to travel from the LIDAR system to the object and the system return signal to travel from the object to the LIDAR system when the object is positioned at the crossover distance from the LIDAR system.

8. The system of claim 7, wherein the switch controller is configured to operate the switch such that the data signal output from the switch changes at the time equal to the start of the chirp period plus a roundtrip time +/−10% of the roundtrip time.

9. The system of claim 1, wherein the LIDAR system is configured such that when the object is positioned at less than a crossover distance from the LIDAR system a first one of the comparative waveguides receives the most powerful one of the comparative signals but when the object is positioned at greater than a crossover distance from the LIDAR system a second one of the comparative waveguides receives the most powerful of the comparative signals.

10. The system of claim 1, wherein the data signals are electrical signals.

11. The system of claim 1, wherein the LIDAR system includes a waveguide configured to guide an outgoing LIDAR signal,
the LIDAR system being configured to transmit a system output signal that includes light from the outgoing LIDAR signal, and the system return signal includes light from the system output signal,
the LIDAR system includes light signal combiners, each of the light signal combiners is configured to combine light from one of the comparative signals with a reference signal so as to produce a composite signal beating at a beat frequency, the reference signals including light from the outgoing LIDAR signal.

12. The system of claim 11, wherein the LIDAR system includes light sensors, each of the light sensors being configured to receive a different one of the comparative signals and to convert the comparative signal from an optical signal to an electrical signal.

13. The system of claim 12, wherein each of the light sensors is configured to output a different one of the data signals.

14. The system of claim 11, wherein the LIDAR system includes light sensors, each of the light sensors being configured to receive a composite signal that includes light from a different one of the comparative signals and to output a different one of the data signals.

15. The system of claim 1, wherein the switch is operable so as to output only one of the data signals.

16. The system of claim 1, wherein the switch is an electrical multiplexer.
